(19) United States
(12) Patent Application Publication
(10) Pub. No.: US 2022/0224678 A1
(43) Pub. Date: Jul. 14, 2022

(54) SYNCHRONIZED DATABASE AUTHORIZATION AUTOMATION

(71) Applicant: Delega Treasury AG, Zug (CH)

(72) Inventors: Riccardo Balsamo, Zürich (CH); Patrick Ramseyer, Romanshorn (CH); Robert Lunn, Aspley Guise (GB)

(21) Appl. No.: 17/339,723

(22) Filed: Jun. 4, 2021

Related U.S. Application Data
(60) Provisional application No. 63/137,081, filed on Jan. 13, 2021.

(51) Int. Cl. H04L 29/06; G06F 21/62

(52) U.S. Cl. CPC H04L 63/083; G06F 21/6218

(57) ABSTRACT

Systems and methods here may be used to, by a server computer in communication with a database and at least one user device, receiving an upload of a data file for authorization, processing the received data file for identifiers in a master entity authorization table, wherein processing the identifier is either extracting the identifier from metadata for the data file or extracting the identifier from the data file itself, triggering a process to identify eligible authorities for the received data file.

### CROSS REFERENCE

This application relates to and claims priority from U.S. Provisional Application No. 63/137,081 filed on Jan. 13, 2021 and titled “SYNCHRONIZED DATABASE AUTHORIZATION AUTOMATION,” the entirety of which is hereby incorporated by reference.

### FIELD

This application relates to the field of networking and database cross referencing authorizations for automation purposes.

### BACKGROUND

Authorization may be attributable manually but identifying and updating an authorization schedule for automation is not now known. Whilst identifying the holder of such authority is the responsibility of any given Master Entity, some of its users, notably those holding full authorization and obligation to identify and confirm the authority of counter-parties, may not be known, identifiable, or able to authorize automatically. This will likely involve the User manually reviewing supporting documents such as proofs and documents issued by the Master Entity that would both give and place limits on the authority granted. But even then, such authorizations may be ended, revoked, or otherwise terminated as outdated. Further, dissimilar databases may store data in different formats, using non-uniform updates and tracking systems. A single repository is therefore not yet utilized or contemplated. Such information is not standardized across all users, no single source details requirements of all users, and no common automated rules-based processing is executed across all users. When a Master Entity issues an update, there is a low probability it will be accepted first time right due to the lack of transparency around requirements and lack of automated rules-based processing.

Due to the lack of a comprehensive, up-to-date view of the Master Entity's data across all users, it is not possible to automatically offer digital options to a user with certainty that the user is authorized to sign that particular type of agreement or contract. The systems and methods here resolve these issues.

### SUMMARY

System and methods here may include a network device including a processor in communication with a memory and data storage, for, by a server computer in communication with a database and at least one user device, receiving an upload of a data file for authorization, processing the received data file for identifiers in a master entity authorization table, wherein processing the identifier is either extracting the identifier from metadata for the data file or extracting the identifier from the data file itself, triggering a process to identify eligible authorities for the received data file, wherein identification includes a database look-up to identify authorities for the correlated type of underlying substantive data file, sending a notification message to the identified authority systems, receiving executed authorizations for the data file from each identified authority systems in response to the sent notification message, comparing the received executed authorizations to a rule for the data file, if the rule is satisfied, sending an electronic message notification to the user system application, receiving identified counter-authorities for the data file, sending notification messages that authority executions are required to finalize the authority process for the data file, receiving executed authorizations for the data file from each identified authority systems, comparing the received executed authorizations to a rule for the data file to check if the correct number of executed authorizations was received, if the compared received executed authorizations were received, by the server computer, finalizing authorization of the data file, causing storage of the authorization for the data file in the master entity database, and sending final authorization notice to the user system.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an example prior art diagram.

FIG. 2 is an example flowchart network diagram depicting an example set of steps for the systems and methods described herein.

FIG. 3 is an example flowchart network diagram depicting an example set of steps for the systems and methods described herein.

FIG. 4 is an example flowchart network diagram depicting an example set of steps for the systems and methods described herein.

FIG. 5 is an example flowchart depicting an example set of steps for the systems and methods described herein.

FIG. 6 is an example computing device which may be utilized in the systems and methods described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

The methods and systems described here include solutions to resolve issues with authorization automation. Some examples, alone or in combination include distributed database technologies used by a Master Entity and its users to ensure uniformity of data stored in the same structure and using the same standards for cross-platform accessibility and authorization automation purposes coupled with rules based authentication protocols.

Some example embodiments, alone or in combination, may use synchronized updates across the Master Entity and user databases, for example, the Master Entity may issue updates that are distributed to all relevant users. As soon as these updates have passed automated rules-based checks at each User, the change in status may be automatically registered in the Master Entity database for access across platforms.

Prior Art Example

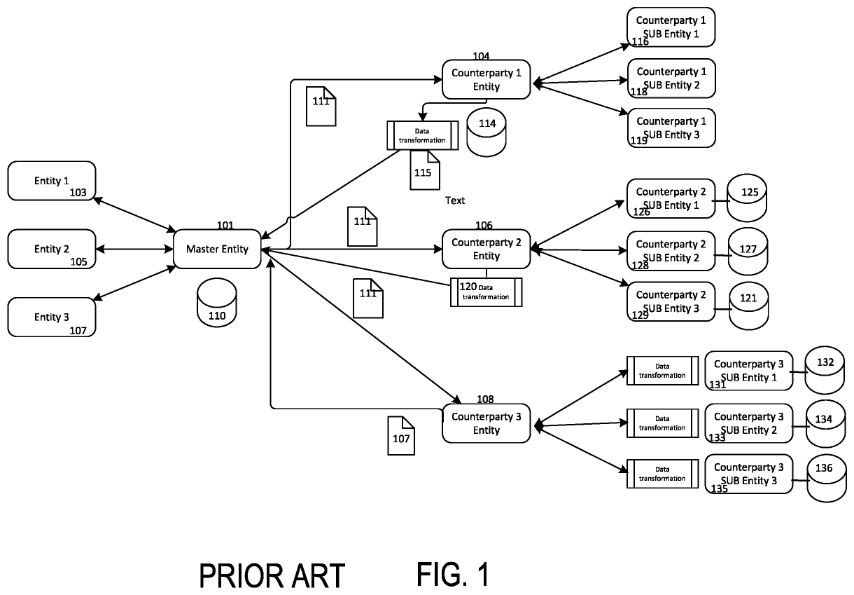

FIG. 1 shows a prior art example and the problems with wasting computer resources, efficiencies, and potential for inaccuracies and errors to occur. In FIG. 1, a Master Entity Head Office 101 wants to obtain an up-to-date, comprehensive set of authorization data from Counter Party Users Entity 1, 103, Entity 2, 105, and Entity 3, 107, to share with Entity 1, 103, Entity 2, 105, and Entity 3, 107, within the Master Entity 101. In the example, each of the three Users in turn has three entities who either hold part of the relevant data or are in a position to validate it. The Master Entity Head 101 has access to a database 110 in which it maintains signatory data, but this is not in a format or structure used by any of the Users.

In process 111 the Master Entity 101 requests each of the three Counter Entities 104, 106, 108 to return their up-to-date data about the Master Entity's 101 signatories, in a data format specified by the Master Entity 101. Due to the disparate technology landscape and different internal processes used by each Counter Entity 104, 106, 108, each Counter Entity may react differently to this request 111. Counter Entity 1, 104, may have a central database 114, although it does not hold data in the same format and structure as the Master Entity 101. Counter Entity 1, 104, may then request each of its own three sub-entities 116, 118, 119, to separately validate the data 111 held in its central database 114. In this example, once the data 111 is validated by the Counter Entity 1, 104 disparate system, it must transform the validated data 115 into the format requested by the Master Entity and return it to the Master Entity Head Office 101.

In the example, Counter Entity 2, 106, does not have a central database for signatory data, rather of its three sub-entities 126, 128, 129 holds the data relevant to them independently. The data is also held in different formats, for one entity this is structured data in spreadsheets, for another in a relational database whereas one entity holds scanned images of original letters, forms etc. in an image archive, each in separate databases 125, 127, 121. Counter Entity 2, 106 then requests each of its sub-entities 126, 128, 129 to return the relevant data in the form and structure that they store it. Next, once the data is received by Counter Entity 2, 106, it must transform the data received from the entities from the three formats it is delivered in 120, into the format requested by the Master Entity 101. Having done this, Counter Entity 2, 106 may return the data to the Master Entity Head Office 101.

In the example, Counter Entity 3, 108 also does not have a central database for signatory data, and like Counter Entity 2, 106 each of its three sub-entities 131, 133, 135, holds the data, for example, in different formats, such as software spreadsheets, digitized image files or in a relational database. Counter Entity 3, 108 may then request the data in the format required by the Master Entity 101 from each of the sub-entities 131, 133, 135. As a result, each of the three sub-entities 131, 133, 135 must transform or convert their own data individually. In the example, once Counter Entity 3, 108 receives the data back from the three sub-entities 131, 133, 135, all it needs to do is consolidate the three datasets, which are now in consistent formats, into a single dataset 107 and return it to the Master Entity 101. Finally, once the Master Entity 101 receives the consolidated data 115, 120, 107 back from all three Counter Entities 104, 106, 108, it can compare it to the data the Master Entity Head Office 101 holds in their database 110 and share with the entities.

It should be noted that in the prior art, there is no standardized form of communication between the Counter Entities and their separate individual sub-entities, nor between the Master Entity and the Counter Entities. Some of the communication may well be conducted via e-mail, others within workflow applications used by a single User. Similarly, whilst some technology tools such as OCR (Optical Character Recognition) can assist in the data transformation tasks, there is no consistency across the Users in their use and manual intervention may even occur.

As a result, there is a high risk of data transposition errors and the whole process takes time. The Master Entity may not get a response from all Users in near real-time, nor on the same working day. In practice such a request frequently takes weeks to fulfil. Any updates previously requested by the Master Entity would have followed a similar communication and data transformation process (albeit in reverse), and these are also prone to error; so there is also a high probability that once the Master Entity gets back the data it has requested from all Counter Entities or Users, it will not match the data the Master Entity holds centrally.

The process in FIG. 1 to review and update signatory data are inefficient in usage of computer resources and prone to error, and in turn this creates other risks for both the Master Entity and its Counter Entities or Users. The process of reviewing signatories is frequently a requirement of the Master Entity auditors, so accuracy is a requirement. Signatory data is used to validate whether an individual entity is authorized to perform a given action, in some examples, authorizing or signing or approving a particular data set. If the Master Entity and the Counter Entity hold different data and cannot jointly validate whether a user is authorized, this will delay transactions and processes tied to and dependent on authorizations. In the worst case, if a user who the Master Entity no longer regards as a valid authorizer remains in the dataset of a Counter Entity, there is a risk that the individual could, in error, or due to fraudulent or malicious intent, be used as an authority despite updates to such status.

Example Architecture Diagram for Embodiments

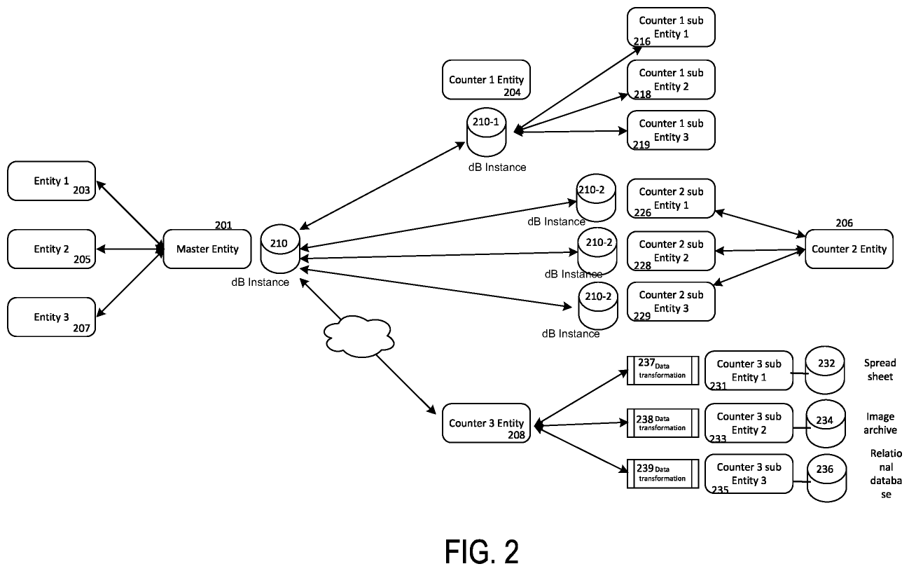

To better described the solutions to the problems outlined in FIG. 1, FIG. 2 shows how the systems and methods here enable the sharing and synchronization of authorization data across the Master Entity 201 and all its Counter Entities or Users 204, 206, 208, enable efficient use of computer resources, eliminate errors, and synchronize updates to remove the possibility of out-of-date authorizations occurring.

In the example of FIG. 2, the Master Entity 201, Counter Entities or Users 1, 204, and 2, 206, have implemented the systems and methods here, including a common, standardized database 210 usage, and common, standardized data formatting, plus software enabling communication and updates among any applications, API and interfaces to the system. By suing such synchronized systems, data may be stored in a repository 210 and the location of that data will be known, and be accessible by the database 210 that is updated by the system.

In the example, Counter Entity, or User 1, 204 has installed the systems and methods at computer systems in the Master Entity 201. By so doing, the Master Entity 201 may share data with Counter Entity, User 1, 204 and its respective database instance 210-1. By synchronizing the Master Entity database 210 and that instance used by Counter Entity User 1, 204, at 210-1, all updates are immediately executed in any data set that resides in both the Master Entity and Counter Entity, User 1 database instances 210, 210-1, meaning both parties have the same view of the updated data, including user lists, authorizations lists, and any rules.

In the example, Counter Entity User 1, 204 has granted read and write access to the data to each of its sub-entities, 216, 218, 219 enabling updates made by the individual sub-entities to be immediately shared with the Master Entity 201. Each sub-entity 216, 218, 219 only has access to the data that is relevant to that entity, they can view that data either in an application itself, or the application can be interfaced to other applications and systems such as workflow tools where the data can be viewed and worked on.

Compared to the prior art scenario as described in FIG. 1, by implementing the systems and methods here, Counter Entity, User 1, 204 now has no data transformation activities to perform and can be certain that the data that it and its sub entities, 216, 218 and 219 are all accurate and up to date.

In the example, Counter Entity, User 2, 206 utilizes the systems and methods described here, but in a distributed manner, at each of its three sub-entities, 226, 228, 229. In such examples, data may be shared between the Master Entity 201 and its database instance 210 and each of User 2 sub-entities, 226, 228, 229, and their respective database instances 210-2. Such an arrangement may also enable data segregation in that each of User 2 sub-entities has access only the data relevant to that respective entity. In such examples, every instance has a web service on their own system, so when an update is requested and/or sent to the underlying data in the database 210-2, it goes to a Unique URL of that particular entity and negotiates with the web service. Security may be ensured using private key sets, so only those who have the key can update the system. Such keys may be embedded into the system, making it impossible to update an instance unless that entity possesses the correct key. In such a way, all updates may be immediately executed in both the Master Entity and the relevant entities dataset, meaning both parties have the same view of the data, but each party has their own instance of the database.

In the example, the sub-entities, 226, 228, 229, can grant Counter Entity User 2, 206 or indeed any other entity, read or read-and-write access to their data, enabling Master Entity 201 to gain an overview of the data relevant to the Master Entity 201, and if granted read-and-write access the ability to make changes that will also be immediately communicated to the Master Entity 201.

Whether, like Counter Entity User 1, 204, the systems and methods are centralized or, like Counter Entity User 2, 206, de-centralized at the sub-entity level, the practical outcome may be the same. In both, the datasets held by both the Master Entity 201, the Counter Party User 204, 206, and all relevant sub-entities, 216, 218, 219, 226, 228, 229, etc. may be updated in a synchronized manner, meaning all participants have the same view of the data, they can retrieve it immediately for reporting, review or other tasks (either viewing it in the application or in other applications that can be interfaced to the system), and there are no longer high risks of discrepancies between the datasets held by the parties.

In such examples, every instance has a web service on their own system, so when an update is requested and/or sent then it goes to a Unique URL of that particular entity and negotiates with the web service. Security may be ensured using private key sets, so only those with the key can update the system. These keys are embedded into the system making it impossible to update an instance without the correct key.

In the examples, the data may be mainly made up of unstructured data, such as but not limited to PDFs, Image Files, etc. and structured data inside the Database. The entire rights to accessing this data may be subject to two things: 1) the Entity's data protection policy and 2) the rights allocated to each user of the system by the super administrator. The granular level of authorization may or may not be contained in the meta data of the file. In instances where the authorization is not in the file metadata, it may be ascertained by the above permissions.

It should be noted that the example of one, two, or three Counter Entities, Users, and/or sub-entities is not intended to be limiting in any way, and any number of such assets could be utilized, interacted with, and/or utilize the systems and methods here. There are no number, minimum or maximum, of such computerized systems may be used or interacted with. The numbers in the written description and figures is merely demonstrative and not intended to be limiting.

Unsynchronized Example

Still referring to FIG. 2, User 3, 207 has not implemented the systems and methods described herein, however, the Master Entity 201 can still maintain data relevant to User 3 207 in their database.

In such examples, when the Master Entity 201 wishes to check that the data it holds relevant to User 3, 207 is up-to-date, it sends a request to Counter Entity, User 3, 208. This request can be in the form of an electronic message over a shared communication network, or as here a request to enter the data Counter Entity, User 3, 208 holds relevant to the Master Entity in a web-enabled application accessible via a URL.

In such examples, Counter Entity, User 3, 208 may have to go through many of the same activities to gather and validate data internally as it would in FIG. 1, the prior art. In this case, that means requesting data from three sub-entities, 231, 233, 235, each of which store it in different formats, 232, 234, 236, and then ensuring the data is transformed into a common format 237, 238, 239, that can then be entered into the web application and sent back to Master Entity 201. There are fewer efficiency gains for Counter Entity, User 3, 208 in this scenario as compared to the using the systems and methods here, but this decentralized format still enables the Master Entity 201 to hold data for all its Users in the application, whether or not those users have implemented the systems and methods described herein.

Also, in any combination of examples, the Master Entity 201 may grant read, or read-and-write access to each of its entities or sub-entities to the data relevant to them.

Multiple Master Entity Examples

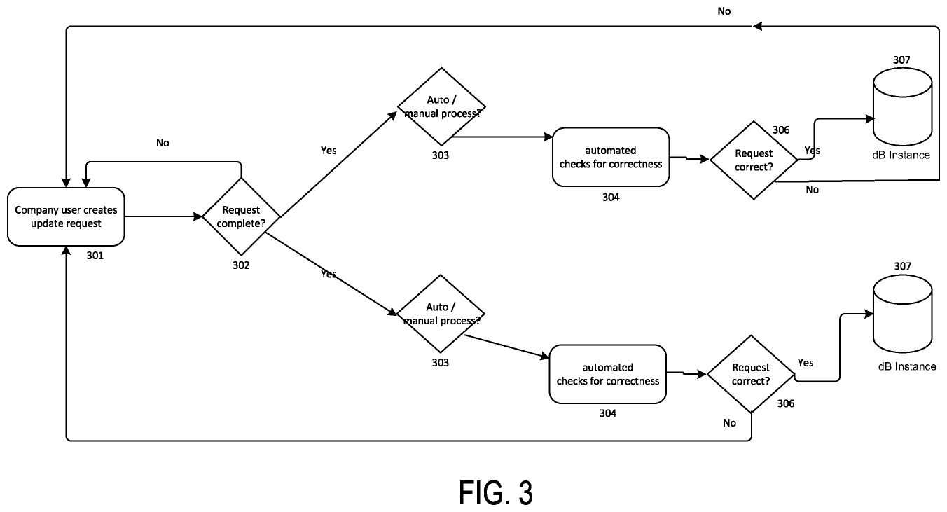

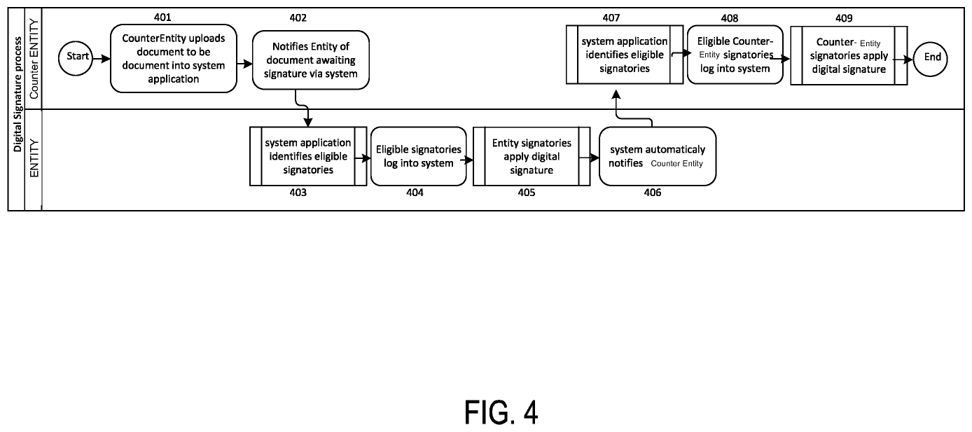

The systems and methods described here may also be implemented by a User that wishes to offer multiple Master Entities the ability to view their data and request updates. In this scenario, the User may hold all the data and offer multiple Master Entities the ability to access web-enabled application to view their data and request updates. The same rules-based processing for updates as described below in FIG. 3 will still apply, and the User may be able to offer all the Master Entities the ability to utilize a digital signature as shown in FIG. 4 whilst ensuring that the users signing contracts with that digital signature are properly authorized to sign contracts of that specific type.

FIG. 3 is a flow chart showing how the systems and methods here enable updates to be made to the Master Entity's database. For the sake of clarity, in FIG. 3 the individual entities are removed to focus on the actions carried out by the Master Entity in requesting an update and the Users in processing those updates. In practice, the update could be requested by any of the Master Entity entities that have the required access rights and processed by the relevant User entities.

FIG. 3 at 301: the Master Entity creates an update request. This may be either a request to add or delete a user entry from the list of approved entries, or to amend the authorization rights of a user entry or group of user entries. Requests of this type typically also require supporting authorizations. In some examples, supporting authorizations may be saved in the database for the Master Entity to check on each user entry of the exact requirements for each User, which may also differ depending on the type of authorization. Details of the request may be stored in the Master Entity database, but only in a pending (non-accepted) status, so it will be clear to the Master Entity that the Users have not yet accepted this update. Once a pending update has been received it may be placed into a waiting queue. Such a queue may be a separate table/Flag on the database record. This record may only be modified by the authorized entity and may remain in that state until that is done. The data may only be accessible by an entity that is authorized.

Still referring to FIG. 3, at 302: the systems and methods support automated rule-based processing. At this stage, the rules may be arranged with a list of requirements of authorizations for each relevant User, established as rules. If these requirements have not been met, the request cannot be submitted further and will be returned to the Master Entity for completion. The request may be required to be supported by a complete set of the required authorizations. If all requirements have been met, the request will be sent onwards to the Users (in the example of FIG. 3, there are two Users).

The example shows then that if the request is complete with all supporting authorizations, a further check may be carried out by each User to determine whether the request and the supporting authorizations are correct. This means ensuring that the supporting authorizations refer to the correct user and are valid.

303: based on pre-configured and stored rules, the User may use the capabilities of the systems and methods to carry out an automated check for completeness.

304: if the request is submitted to automated checks for completeness, the metadata associated to each of the authorizations may be compared automatically to the records entered by the Master Entity on the user, and data elements such as, but not limited to, the date of issue for proofs compared to the validity ranges stored in the databases. If the request passes these checks, it will be sent to the next stage 306, if it fails it may be returned to the Master Entity with an explanation as to what data element and supporting document were deemed incorrect/unsatisfactory.

306: once the system deems the request is correct, and passed all established rules, it will be written as an update to the User database. Following the processed described in FIG. 2, an update message will then be sent to the Master Entity database confirming that the request has now been accepted by the User. As a result, both the Master Entity and User databases will be synchronized.

Authorization Level Examples

FIG. 4 is a flowchart detailing examples of how a digital signature capability may be enabled for users based on the authorization approval levels detailed in the Master Entity and User data:

In such examples, in the first step 401: the User uploads the underlying substantive data files into the system to be authorized. The underlying substantive data files may include identifiers that correspond to the Master Entity authorization tables. Such a correlation may either be identified at upload, or through file metadata, or in some examples, an optical character recognition (OCR) process may be applied to the underlying substantive data files and certain key terms may be searched and correlated to the authorization tables. Any combination or permutation of these methods, singularly or multiply, may be used to determine corresponding Master Entity authorizations.

In some examples, the data file could be any number of data files including but not limited to, a digital computer file including images, text, code, spreadsheets, calculations, and/or any other kind of data alone or in any combination. In some examples, authorization could take any manner or form including but not limited to a digital signature, digital watermark, tokenized key, encryption key, biometric signature, and/or any other kind of authorization alone or in any combination. In some examples, hashes in a blockchain arrangement may be used to notarize the integrity of a document.

402: the system may then send a notification to the Master Entity that an underlying substantive data file is awaiting authorization. In some examples, this may be by way of an electronic message sent from the User system to that of the Master Entity.

403: upon receipt of the message, the notification message from the User may trigger a process within the Master Entity application to identify eligible authorities for this specific type of underlying substantive data file. This process may include a look-up, cross-reference, or correlations search into the Master Entity database authorization tables to identify authorities that match or are previously designated for the correlated type of underlying substantive data file that was received and is awaiting authorization. In some examples, triggering the process to identify eligible authorities includes requesting an update to the database to ensure authorities are current and accurate at the time of the request. Once identified, the eligible authority entities may receive notification messages from the Master Entity application, as described herein.

404: on receipt of the notification message, eligible authorities may log-into the system by way of a software application. In some examples, the message itself may include code, key, login link or a password that allows only the eligible authorities to log into the system. In some examples, the system may pre-authorize the accounts of the eligible authorities, so that when any one of the eligible authorities logs into the system to approve, the system allows them, but not any others with login credentials that are not correlated to the eligible authority entities. In such a way, only authorized users may access the approval systems for a particular file requesting authorization,

405: the system may present the underlying substantive data files to the system in response to the request from the eligible authority and execute authorization for the underlying substantive data file. Only entities or user accounts with proper authorization levels, as recorded and stored in the Master Entity database, may execute authorization for each particular corresponding data file.

In some examples, a signature scan for the digital signature may be used to make sure it matches with a saved copy to augment the authorization/authentication before signature using such examples as a Biometric passport authentication, digital image matching, video call, fingerprint capture, retinal scan, and/or any other kind of biometric authentication and matching arrangements.

In some example embodiments, multiple authorities may be required to complete an authorization for a single underlying substantive data file. In such examples, a rule may be programmed for the underlying substantive data file that it is to remain open for authorization until the required number of authorities have been executed, check and update the correct authorizations, and hold final authorization until the rule is satisfied. In some examples, the system may determine the number and combination of users required, using predefined rules and/or logic coded into the system. In some examples, a particular order of authorizations may be required, where different levels of authorizations, each with a group of eligible authorization entities must approve, in the particularly pre-arranged and stored order. In some examples of multiple authorizations and order, a second level authorization request is not sent until the first level of authorization is completed as described here, and only after the predetermined number of authorization levels have been completed, is the final authorization granted as described.

406: once the correct number of authorities have been executed, according to the rule or rules, and any other established rules are satisfied, the Master Entity application may send a notification to the User system application via an electronic message, as described herein.

407: if required, the Master Entity application may identify eligible or pre-approved counter-authority entities. In such examples, the system may perform database searches for previously stored lists of eligible or pre-approved counter-authorities and cross-reference look-up to identify those correlated counter-authorities. In some examples, this identification of counter-authorities is dependent upon a specific type of underlying substantive data file. Thus, in this example, one type of underlying date file may include one list of approved counter-authorities, and a second type of underlying data file may include a second list of approved counter-authorities. In some examples, the first list and second list may include some overlapping counter-authorities that are approved for both first and second underlying data files. In some examples, the first list and second list of pre-approved counter-authorities may be completely different. Once identified by the Master Entity application, the list of pre-approved or eligible counter-authorities may be sent notification messages that authority executions are required to finalize the authority process for a data file. In some examples, the Master Entity application may utilize the list of previously approved or eligible counter-authorities to inform the Counter Entity of the list.

In some examples, the message itself may include code, key, login link or a password that allows only the eligible counter authorities to log into the system. In some examples, the system may pre-authorize the accounts of the eligible counter authorities, so that when any one of the eligible counter authorities logs into the system to approve, the system allows them, but not any others with login credentials that are not correlated to the eligible counter authority entities.

408: on receipt of the notification message, eligible counter-authorities may be allowed by the system to log-into the system by way of a software application as described.

409: the system may present the underlying substantive data files to the system in response to the request from the eligible authority and execute authorization for the underlying substantive data file. Only entities with proper authorization levels as stored in the Master Entity system, may execute authorization for each particular corresponding data file.

In some example embodiments, multiple authorities may be required to complete an authorization for a single underlying substantive data file. In such examples, a rule may be programmed for the underlying substantive data file that it is to remain open for authorization until the required number of authorities have been executed.

Because only the eligible counter-authorities are allowed access to log into the system by way of the software application, the Counter Entity can be sure that if the counter-entity signatories apply a digital signature, that those counter entities were previously verified and approved.

Once the correct number of authorities have been executed, and all rules satisfied including counter-authority executions, the Master Entity application may finalize authorization. The underlying substantive data file at that time is formally authorized and both the Master Entity and User applications may be updated to show that authorization is complete. In some examples, the Master Entity application then sends a message with credentials to the User application, indicting formal authorization of the submitted underlying substantive data file.

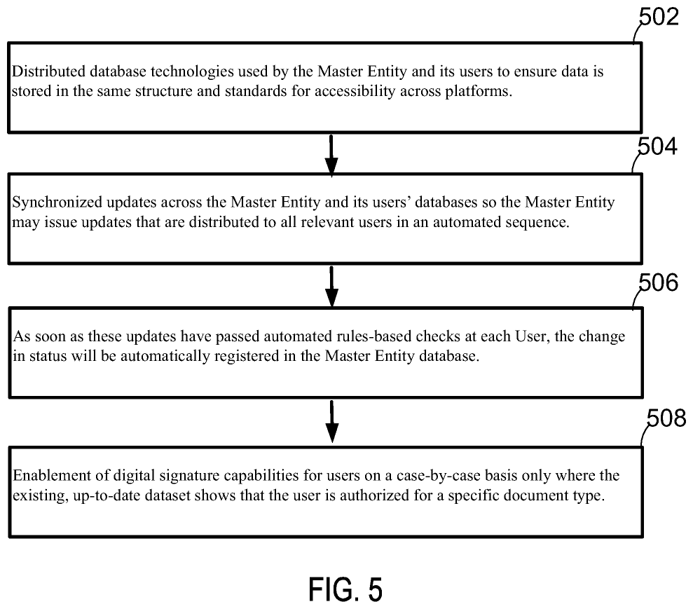

Some example embodiments, alone or in combination, as shown in FIG. 5 may enable digital capabilities for users on a case-by-case basis only where the existing, up-to-date dataset shows that the user is authorized for a specific document or underlying data file type. Distributed database technologies may be used by the Master Entity and its users to ensure the data is stored in the same structure and standards for accessibility across platforms, 502.

Synchronized updates across the Master Entity and its users' databases may allow the Master Entity to issue updates that are distributed to all relevant users automatically, 504. As soon as these updates have passed automated rules-based checks at each User, the change in status will be automatically registered in the Master Entity database, 506.

Such use of distributed databases may enable use of digital signature capabilities for users on a case-by-case basis only where the existing, up-to-date dataset shows that the user is authorized for a specific document type, 508. Such authorization matching may occur dynamically and for automated authorization granting.

In various embodiments, systems and methods here may resolve these issues by providing the Master Entity and its users with at least one of, or any combination of, the following:
Distributed database technologies used by the Master Entity and its users to ensure data is stored in the same structure and standards for accessibility across platforms.
Synchronized updates across the Master Entity and its users' databases so the Master Entity may issue updates that are distributed to all relevant users in an automated sequence. As soon as these updates have passed automated rules-based checks at each User, the change in status will be automatically registered in the Master Entity database.
Enablement of digital signature capabilities for users on a case-by-case basis only where the existing, up-to-date dataset shows that the user is authorized for a specific data file type.

Example Computing Equipment

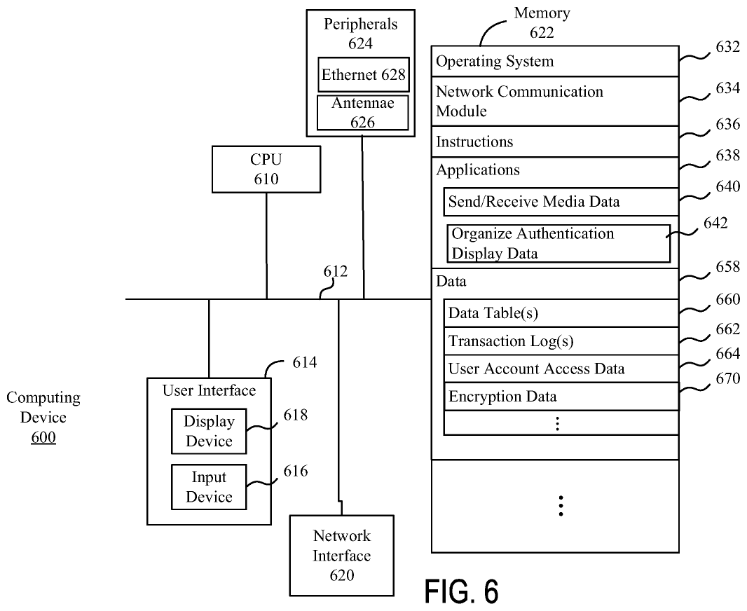

FIG. 6 shows an example piece of computing equipment 600 such as the Master Entity system 102, and/or Counter and/or User Entity systems 116, etc. from FIG. 1 and all counterparts as described in the various figures, used as described herein. The computing device 600 of FIG. 6 is shown with a central processor CPU 610 that could include any number of computer processors. The CPU 610 is shown in communication via a bus 612 or other way to a number of features including a user interface 614. The user interface 614 could include a display 618 such as a screen or lights and/or input device 616 such as a touchscreen, buttons, keyboard, mouse, wheel, rollerball, joystick, etc. The CPU 610 is also shown in communication with a network interface 620 as well as peripherals 624 such as antennae 626 for the various wireless communications such as WiFi, cellular, infrared, Bluetooth Low Energy, etc. Also shown is an Ethernet 628 connection which could be any kind of wired connection. The CPU 610 is also shown in communication with a memory 622. The memory includes software instructions which are executed by the CPU 610 to perform tasks. The memory 622 is shown including an operating system 632 a network communication module 634, instructions for other features 636 and applications 638 such as sending and receiving media data 640 and organization of authentication display data 642. The data storage 658 includes storage of various data arranged in a data table 660, transaction log 662, which can store user account access data 664 and encryption data 670.

### CONCLUSION

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The innovations herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the present inventions may be implemented via computer-hardware, software and/or firmware. For example, the network systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

1. A method, comprising:
by a server computer in communication with a database and at least one user device application,
receiving an upload of a data file for authorization;
by the server computer, processing the received data file for identifiers in a master entity authorization table,
wherein processing the received data file for an identifier is either extracting an identifier from metadata of the data file or extracting an identifier from the data file itself;
by the server computer, triggering a process to identify eligible authorities for the received data file,
wherein identification includes a database look-up to identify authorities for a correlated type of underlying substantive data file;
by the server computer, sending a notification message to an identified authority,
wherein the notification message to the identified authority, includes at least one of a code, key, login link or a password that allows only the eligible authority to log in;
by the server computer, receiving executed authorizations for the data file from each identified authority in response to the sent notification message;
by the server computer, comparing the received executed authorizations to a rule for the correlated type of underlying substantive data file;
by the server computer, if the rule is satisfied, sending an electronic message notification to the user device application;
by the server computer, sending a request for counter-authorities and receiving identified counter-authorities for the correlated type of underlying substantive data file;
by the server computer, sending notification messages to the identified counter authorities that authority executions are required;
by the server computer, receiving executed counter authorizations for the data file from each identified counter authority;
by the server computer, comparing the received executed counter authorizations to a rule for the correlated type of underlying substantive data file to check if a correct number of executed authorizations was received;
if the compared received executed counter authorizations were received, by the server computer, finalizing authorization of the data file, causing storage of the authorization for the data file in the master entity database, and sending final authorization notice to the user device application.

2. The method of claim 1 wherein the rule is a check if a correct number of executed authorizations was received.

3. The method of claim 1 wherein triggering the process to identify eligible authorities for the received data file includes requesting a synchronized update to the database.

4. The method of claim 1 wherein identifying eligible authorities includes a cross check that the eligible authority is authorized for a specific type corresponding to the data file for authorization.

5. The method of claim 1 further comprising, receiving another upload of a data file for authorization from a different user.

6. The method of claim 1 wherein the authorization includes a digital signature.

7. The method of claim 1 wherein the data file for authorization is an image file.

8. (canceled)

9. The method of claim 1 further comprising, by the server computer, pre-authorizing accounts of the eligible counter authorities to be able to log in, but not any others with login credentials that are not correlated to the eligible counter authority entities.

10. The method of claim 1 wherein the sent notification messages to the identified counter authorities, that authority executions are required to finalize the authority process for the data file includes at least one of a code, key, login link or a password that allows only the eligible authorities to log in.

11. A system, comprising:
a server computer in communication with a database and at least one user device application, the server computer configured to,
receive an upload of a data file for authorization;
the server computer further configured to, process the received data file for identifiers in a master entity authorization table,
wherein processing the identifier is either extracting the identifier from metadata for the data file or extracting the identifier from the data file itself;
the server computer further configured to, conduct a lookup in a database
to identify authorities for the correlated type of underlying substantive data file;
the server computer further configured to, send a notification message to an identified authority from the lookup in the database,
wherein the notification message to the identified authority, includes at least one of a code, key, login link or a password that allows only the eligible authorities to log in;
the server computer further configured to, receive executed authorizations for the data file from each identified authority in response to the sent notification message;
the server computer further configured to, compare the received executed authorizations to a rule for the data file;
if the rule is satisfied, the server computer further configured to send an electronic message notification to the user device application;
the server computer further configured to, receive a list of identified counter-authorities for the data file;
the server computer further configured to, send notification messages to the identified counter authorities, that counter authority executions are required;
the server computer further configured to, receive executed counter authorizations for the data file from each identified counter authority;
the server computer further configured to, compare the received executed counter authorizations to a rule for the data file to check if a correct number of executed counter authorizations was received.

12. The system of claim 11 wherein if the compared received executed counter authorizations were received, the server computer further configured to, finalize authorization of the data file, causing storage of the authorization for the data file in the master entity database, and sending final authorization notice to the user device application.

13. The system of claim 11 wherein the rule is a check if a correct number of executed authorizations was received.

14. The system of claim 11 wherein triggering the process to identify eligible authorities for the received data file includes requesting a synchronized update to the database.

15. The system of claim 11 wherein identifying eligible authorities includes a cross check that the eligible authority is authorized for a specific type corresponding to the data file for authorization.

16. The system of claim 11 the server computer further configured to, receive another upload of a data file for authorization from a different user.

17. The system of claim 11 wherein the authorization includes a digital signature.

18. The system of claim 11 wherein the data file for authorization is an image file.

19. (canceled)

20. The system of claim 11 further comprising, by the server computer, pre-authorizing accounts of the eligible counter authorities to be able to log in, but not any others with login credentials that are not correlated to the eligible counter authority entities, and
wherein the sent notification messages to the identified counter authorities, that authority executions are required to finalize the authority process for the data file includes at least one of a code, key, login link or a password that allows only the eligible authorities to log in.
